(19) United States
(12) Patent Application Publication
(10) Pub. No.: US 2024/0177104 A1
(43) Pub. Date: May 30, 2024

(54) SYSTEM AND METHOD FOR TRACKING SHIPPING CONTAINERS

(71) Applicant: Alfonso Llanes, Miami, FL (US)

(72) Inventor: Alfonso Llanes, Miami, FL (US)

(21) Appl. No.: 18/431,694

(22) Filed: Feb. 2, 2024

Related U.S. Application Data
(63) Continuation-in-part of application No. 18/203,589, filed on May 30, 2023.
(60) Provisional application No. 63/346,724, filed on May 27, 2022.

(51) Int. Cl. G06Q 10/0833; G06F 16/955; G06K 7/14

(52) U.S. Cl. CPC G06Q 10/0833; G06F 16/9554; G06K 7/1417

(57) ABSTRACT

A system and method for tracking shipping containers uses QR codes that are affixed to each container providing extensive data that is particular to each container, including the size of the container, the weight of the container, as well as the location of the container upon scanning the QR code with a QR scanning device, such as a smartphone. The system and method of the present invention further incorporates the use of a website and software that allows for a setup of automated emails and notifications, as well as communication with the devices that scan the QR code on each container.

### BACKGROUND OF THE INVENTION

This non-provisional patent application is a Continuation-In-Part of non-provisional patent application Ser. No. 18/203,589 filed on May 30, 2023, which is based on provisional patent application Ser. No. 63/346,724 filed May 27, 2022.

### FIELD OF THE INVENTION

This invention relates to tracking the location and movement of shipping containers overseas and on land and railways. More particularly, the invention relates to a system and method that uses QR codes affixed to each shipping container that allows for scanning, location tracking and other identification of any particular shipping container and without the need for battery powered tracking devices attached to the containers or other specialized and complex devices and components.

### DESCRIPTION OF THE RELATED ART

Most goods are shipped across country and overseas in steel or aluminum shipping containers that are carried by merchant ships, trucks and trains from their point of origin to the final destination. The need to constantly identify and track the location of shipping containers has become an increasing concern to shipping companies, manufacturers, merchants, shipping container owners and government agencies, including homeland security. In the United States, 36% of heavy-duty cargo vehicles on the road are empty. According to the Bureau of Transportation Statistics, this usually happens because there are no nearby loads accessible for the driver to pick up that are heading in the same direction as the driver (otherwise known as a “backhaul”). These miles are referred to as empty miles, non-revenue miles, or deadhead miles in the freight business. When determining how much they charge for any given cargo, carriers account for their own expectations of empty miles. So, everyone from shippers to end-users, as well as the environment, pays the price for empty miles in the end. If shippers were to get loads on their backhaul drive, they would be competing with brokers to provide equivalent services by facilitating those loads. These shippers would need to implement a system to address insurance, risk, and contracts, along with payment collection and management. To secure backload, trucking companies typically work with brokers or with multiple customers who may have delivery requirements in nearby locations. Fleet operators typically use fleet management and cargo delivery tools to plan trips and identify backload opportunities. However, due to the inability to cost effectively and reliably track all available shipping containers using universal and readily available devices and technology, there remains a high percentage of empty containers on the road and empty miles in the freight transportation industry.

More than two-thirds of the world's trade is seaborne, and the number of shipping containers on the seas and roadways is exploding. In 2014, the United States alone imported over $1.73 trillion worth of goods through its shipping ports. The world shipping container market in 2022 was valued between $8.6B and $61.3B. The great majority of containers are owned by either maritime shipping companies or container leasing companies. At the beginning of the 2020s, about 60% of the equipment available for location was controlled by five leasing companies having fleets exceeding 1 million TEU (Twenty-Foot Equivalent Unit). If the 13 largest leasing companies are considered, they account for 90% of the global container leasing market and control the equivalent of 10.7 million TEU arriving in a market as imports that must eventually leave, either empty or full.

There are few opportunities to load empty containers on the backhaul trip, and an efficient repositioning system must be in place to ensure the overall productivity of the distribution system. There is an urgent need for improving the efficiency of existing cargo rotation with a better link between import and export activities by synchronizing flows. Instead of returning directly to the rail or maritime terminal, an empty container can be brought immediately to an export location to be loaded. However, an asymmetry between import and export-based logistics makes this a difficult proposition.

Beyond the maritime and rail transportation industries, movement of shipping containers and cargo in the trucking industry has its challenges. When it comes to logistics, over 72% of all freight tonnage in the United States is moved via the nation's highways, according to the American Trucking Association; making inland transportation a crucial element of logistics for businesses in the US market. But today, the trucking industry is facing a capacity crisis. It's being driven by a shortage of drivers and made worse by the ripple effect of other pressures and disruption being seen across global supply chains and logistics, including:
Addressing Client Expectations
Cross Border Expenditures
Digital Evolution & Automation
Security and Cyber Security
Supply Chain Disruptions
Maintaining Safe Practices
Integrating Legislative Protocol
Fatigue Management

Backhaul trucking is a great way for truckers and fleet owners to make money on return trips, while providing shippers with another opportunity to move their products where they need to go at a lower freight rates.

In the rail transportation industry, more than one-third of a railroad's car miles are due to empty car movements. The cost of empty rail car movements is thus a significant portion of a railroad's variable cost. The cost of these empty movements must be allocated to movements of loaded cars to determine the full cost of each loaded move.

In the past, others have proposed various devices and methods for identifying the location of shipping containers and, in some cases, tracking the movement of shipping containers within a shipyard, on highways, and overseas. Some of these proposed methods involve the use of radiofrequency identification devices (RFID) that are attached to the shipping container. This method has been proven to be unsatisfactory, as it is limited by poor scalability, RF noise and interference, lack of real-time alerting, as well as short range of the infrastructure that is required to read and communicate with the RFID devices. Others have proposed the use of Global Positioning System (GPS) technology that requires use of GPS receivers, processors and batteries. Still others have proposed use of battery powered radio transmitting devices that are attached to the containers. The problem with GPS and radio transmission devices is that the devices on the containers require battery operation and eventually the battery power is depleted, requiring replacement and/or recharging of the batteries in each of these devices on each individual container. This constant need to replace or recharge batteries is not practical and results in a large percentage of containers being moved around the world having no battery power in the tracking devices attached to the containers. Additionally, the use of these devices requires a clear path for signal reception and transmission. When containers are stacked, one upon another, or located in cargo holds on a ship, the signal transmission is blocked and, therefore the container cannot be identified or tracked. Moreover, these devices, which are typically affixed to the exterior of containers, are easily damaged and destroyed.

In the last few years, a number of US-based IT companies have developed web-based solutions to the problem. These include SynchroNet Marine Inc, International Asset Systems (IAS), and Maersk Data USA Inc, part of the AP Moller-owned Maersk Data Group. The functionality of these software products varies, but all are essentially tools for repositioning or providing visibility of equipment. They also specialize in different aspects of the transport chain, reflecting the wide range of service providers involved. Some web-based tracking products focus on ocean carriage, others on US intermodal road or rail transportation, while others provide ocean carriers and leasing companies with visibility of equipment.

There remains an urgent and definite need for a highly reliable system and method for identifying and tracking shipping containers around the world, in real-time.

### SUMMARY OF THE INVENTION

The present invention is directed to a system and method for tracking the location and movement of shipping containers. The invention proposes use of QR codes that are affixed to each shipping container providing extensive data that is particular to each container, including the size of the container, the weight of the container, as well as the location of the container upon scanning the QR code with a QR scanning device, such as a smartphone. The system and method of the present invention further incorporates the use of a website and software that allows for a setup of automated emails and notifications, as well as communication with the devices that scan the QR code on each container.

There are plenty of online tools that allow customers to track shipments based on reports from each carrier's private individual system that only customers that can login can access. However, this does not solve the problem of thousands of containers traveling on different carrier lines, arriving at different ports, and at different times. Keeping track of a large number of containers is time-consuming and expensive and currently used systems and technologies have proven to be inadequate and unreliable. The system and method of the present invention provides for use of QR codes on each container, thereby allowing all containers to be scanned to update tracking location and data throughout transport, including:
1. When containers are loaded onto a ship at the port of origin;
2. When the vessel carrying containers departs the port of origin;
3. When the vessel arrives at an interim port (T/S or Trans-Shipment) along the journey;
4. When the vessel departs the port of Trans-Shipment (there can be multiple interim ports);
5. When the vessel carrying the container arrives at the port of destination;
6. When containers are pending customs clearance;
7. When containers have cleared customs;
8. When containers are staged at the port—awaiting pickup, via truck or rail;
9. When containers have left the port via truck or rail;
10. When the container arrives at the shipper;
11. When the consignee is in possession of the shipment.

The system of the present invention provides SMS updates with detailed information for each stage in the supply chain. Customers can set up proactive notifications each time one of their containers reaches a milestone. This visibility enables customers to:
Manage the supply chain;
Save time from having to call different shipping carriers/brokers for updates;
Learn about delays at ports of origin, Trans-Shipment and destination.

Every shipping container is assigned a container number. A container number is a unique alpha-numeric combination of seven numbers and four letters used for identifying containers internationally. It's assigned to each container by the classification agency International Standards Organization (ISO) through the Bureau International des Containers (BIC).

The BIC uses the ISO 6346 standard when assigning the container numbers. Container numbers provide valuable information about the cargo, transportation, ownership, and condition of the shipping container. The ISO code is usually located below the container number. It's a sequence of four letters or digits. It provides information about the container type and dimensions. The first character of ISO code represents the length of the unit and the second character represents the width or height. The third and fourth characters determine the type of container it is. A container number is a unique alpha-numeric combination of seven numbers and four letters used for identifying containers internationally. It's assigned to each container by the classification agency International Standards Organization (ISO) through the Bureau International des Containers (BIC).

A QR code (initialism for quick response code) is a type of matrix barcode (or two-dimensional barcode) invented in 1994 by the Japanese automotive company Denso Wave. In practice, QR codes often contain data for a locator, identifier, or tracker that points to a website or application. QR codes use four standardized encoding modes (numeric, alphanumeric, byte/binary, and kanji) to store data efficiently; extensions may also be used.
QR Code can store up to 7,089 numeric or 4296 alphanumeric characters.
A QR code that when scanned by a smartphones would take a user to a given URL as input of data encoded for management and distribution to all users.
A SMS is automatically generated for notifying the user's query about equipment availability.
A geolocation is provided to a user's query about the location of needed equipment during a given period of time.
The geographic overlay of containers location for a given network is provided for timely scheduling of shipping needs for industrial and agricultural needs.

### BRIEF DESCRIPTION OF THE DRAWINGS

For a fuller understanding of the nature of the present invention, reference should be had to the following detailed description taken in connection with the accompanying drawings in which:

FIG. 1 is a plan view of a typical CSC plate that is affixed to shipping containers providing the information presented thereon;

FIG. 2 is a schematic diagram illustrating the transmission, receipt and flow of data for a shipping container, using the scanning of a QR code affixed to the container, according to the system and method of the present invention;

FIG. 3 is a tracking map illustration that is presented on a computer monitor using the system and method of the present invention, displaying the GPS scanned location of shipping containers on the map;

FIG. 4 illustrates a typical QR code used in the system and method of the present invention; and

FIG. 5 is a general schematic diagram generally illustrating a sequence of operation of the container tracking system and method of the present invention.

### DETAILED DESCRIPTION OF THE PREFERRED EMBODIMENT

The present invention proposes use of QR codes that are affixed to each container providing extensive data that is particular to each container, including the container number, the size of the container, the weight of the container, as well as the location of the container upon scanning the QR code with a QR scanning device, such as a smartphone. The system and method of the present invention further incorporates the use of a website and software that allows for a setup of automated emails and notifications, as well as communication with the devices (i.e., ordinary cellphones or smartphones) that scan the QR code on each container.

A discussion of the technical aspects of QR codes is set forth below. The use of QR codes in the system and method of the present invention provides for a convenient and highly effective means for identifying and tracking shipping containers without the need for any battery power on the containers. Another advantage of using QR codes in the system and method of the present invention is that QR Codes can sustain up to 30% of structural damage and still continue to function and can store up to 7,089 numeric or 4,296 alphanumeric characters.

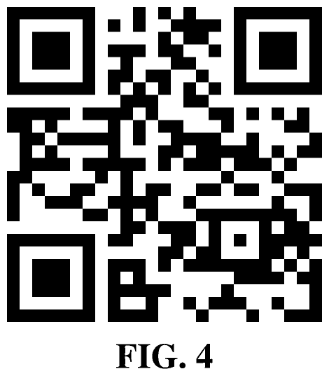

FIG. 4 shows what a typical QR code looks like with the desired information masked behind what appears to resemble a maze.

A QR code (Quick Response code) is a type of matrix barcode (or two-dimensional barcode). In practice, QR codes often contain data for a locator, identifier, or tracker that points to a website or application. QR codes use four standardized encoding modes (numeric, alphanumeric, byte/binary, and kanji) to store data efficiently.

### Some Applications of QR Codes

1. Contact Data—Data is stored in a contact card and can include a person's name, phone number, email address, website and others.
2. Calendar Data—This can include a calendar appointment that can be saved directly into someone's diary when scanned.
3. URL—This is simply a URL that when scanned would be used by a smartphones browser to take a user a given webpage. (The present invention uses this application of QR 9 codes.)
4. Email Address—This could be used to open a blank email with a predefined subject and recipient ready for the user scanning to add content and send.
5. Phone Number—A phone number that when scanned would appear directly in a phones dialer ready to dial or would be saved to the address book.
6. SMS—A new SMS could be opened ready to send to a predefined recipient. (This is another application that is intended to be used in the present invention.)
7. Plain Text—Text can be included that may not have a predefined function but could be used by a bespoke application to carry out any given task. You can store up to 7,089 characters of numerical data or 4,296 alphanumerical characters in a standard QR Code. Micro QR Codes can hold up to 35 numeric symbols.
8. Geo Location—A link to a location that when scanned, can be processed by the reader and used to give directions to an event. (This is another application that is intended to be used in the present invention.)

The following components listed below convey information.
Format information

This contains two pieces of information, the level of error correction chosen, and the index of the mask laid over the original message. Because it is crucial to be able to read this, it is stored in several places. The basic format information is a sequence of bits, 00 through 1414.
Message bits

These contain the actual message. More information about the message bits component and the other parts of the data bytes is provided hereinafter.
Padding

For a given choice of size and error correction level, the number of available words for a message is fixed. But since the message might be somewhat shorter than what is allowed, it is padded with a more or less fixed pattern of bits to fill up space.
Error correction bits

These implement one of the standard BCH coding schemes.

Other examples of applications of QR code include:
QR for bus schedules
QR on tombstones
QR for parking meters
QR parking
QR can find your parked car
QR on menus
QR art

The four encoding modes of QR codes include the following characters:

Numeric mode is for decimal digits 0 through 9.

Alphanumeric mode is for the decimal digits 0 through 9, as well as uppercase letters (not lowercase!), and the symbols $, %, *, +, −, ., /, and: as well as a space. All of the supported characters for alphanumeric mode are listed in the left column of the alphanumeric table.

Byte mode, by default, is for characters from the ISO-8859-1 character set. However, some QR code scanners can automatically detect if UTF-8 is used in byte mode instead.

Kanji mode is for double-byte characters from the Shift JIS character set. While UTF-8 can encode Kanji characters, it must use three or four bytes to do so. Shift JIS, on the other hand, uses just two bytes to encode each Kanji character, so Kanji mode compresses Kanji characters more efficiently. If the entire input string consists of characters in the double-byte range of Shift JIS, use Kanji mode. It is also possible to use multiple modes within the same QR code, as described hereinafter.

Extended Channel Interpretation (ECI) mode specifies the character set (e.g. UTF-8) directly. However, some QR code readers do not support ECI mode and will not understand QR codes that use it.

Structured Append mode encodes data across multiple QR codes, up to a maximum of 16 QR codes.

FNC1 mode allows the QR code to function as a GS1 barcode.

It is possible to use multiple modes in a single QR code by including the mode indicator before each section of bytes that uses that mode. The QR code specification explains how to switch modes in the most optimal way.

Before encoding the data, select an error correction level. QR codes use Reed-Solomon error correction. This process creates error correction code words (bytes) based on the encoded data. A QR code reader can use these error correction bytes to determine if it did not read the data correctly, and the error correction code words can be used to correct those errors. There are four levels of error correction: L, M, Q, H. The following table lists the levels and their error correction capabilities.

| Error Correction Level | Error Correction Capability |
|---|---|
| L | Recovers 7% of data |
| M | Recovers 15% of data |
| Q | Recovers 25% of data |
| H | Recovers 30% of data |

Error correction requires more bytes, so the higher the error correction level, the larger the QR code will have to be.

| Encoding Mode | Maximum number of characters a 40-L code can contain |
|---|---|
| Numeric | 7089 characters |
| Alphanumeric | 4296 characters |
| Byte | 2953 characters |
| Kanji | 1817 characters |

### Static QR Code

Static QR Codes are QR Codes that can't be changed once they are created. These are, for example, email and text Codes, which don't gather any tracking metrics.

### Dynamic QR Code

While Static QR Codes contain fixed information, Dynamic QR Codes have the possibility to be edited after completion. Both the type of QR Code and the content are editable as many times as needed. They use a short URL to send users to the landing page of your desire as well as monitor statistics for information such as the number of scans, location and operating system used.

Static vs Dynamic QR Code, using the latter allows for QR Code tracking. Scan metrics include time scanned, location scanned by city or country, operating device used, and unique vs. total scans. This information not only enables you to use QR Codes for product inventory management and/or container templates, it also allows you to compare them across different time periods and locations.

In the present invention, the QR code provides the following benefits:
QR Code can store up to 7,089 numeric or 4,296 alphanumeric characters.
A QR code can be easily scanned by ordinary smartphones to quickly direct a user to a given URL as input of data encoded for management and distribution to all users.
A SMS can be automatically generated for notifying the user's query about a shipping container location.
A geolocation can be provided in response to a user's query about the location of a needed shipping container(s) during a given period of time.
The geographic overlay of a container's location for a given network can be provided for timely scheduling of shipping needs.

The following is an example sequence of operation of the system and method of the present invention:
1. When a container arrives at a port the receiving vehicle (truck, rail) operator scans the QR codes printed on the containers with a standard cell smart phone which can then be tracked by GPS. Scan metrics include container ID and the particulars of origin-destination time scanned, location scanned by port-city and operating device used.
2. Information is uploaded to a URL which allows SMS automated emails notifications. This includes container type, size, and other particulars and ETA at destination. This software is a Web-based asset tracking software that can be integrated with a number of other business software.
3. Dynamic QR codes that contain URLs to entire container location management websites. Scanning Dynamic QR codes that contain URLs to entire container location management websites to automatically open up a website or even a specific page within the site in the system's cloud.
4. Third party login to server with container characteristics wanted so that an automatic match can be made with the dynamic inventory of container-type layered over a geographic area collected per shipping cycle.
5. An automated email notification is sent when a match is made between equipment query and equipment availability.
6. Generate automated notifications to the carriers-owners of a container-match so that a freight rate and a booking can be made for return voyage.
7. The entire process is repeated for the new booked cargo applying and using the same methodology.
8. Identifying containers by type and function, i.e. dry container and temperature control. Non-standard size, high cube and open top and other functions as it applies.
9. Classifying by functionality for cargo type, volume, packaging, bulk i.e. steel or aluminum containers, and floor density loading per square area. The restrictions listed on the container placard for safety.
10. Backhaul container cargo users can fill up a template of wanted features with booking dates and shipping requirements.
11. Automatically send a SMS to advise the user of a match on the geographic location and dates requirements with contact information of carrier owner or broker.
12. Repeating the process as the new origin/destination is initiated to any location in the world using the cell phone protocol to start a new shipping cycle.

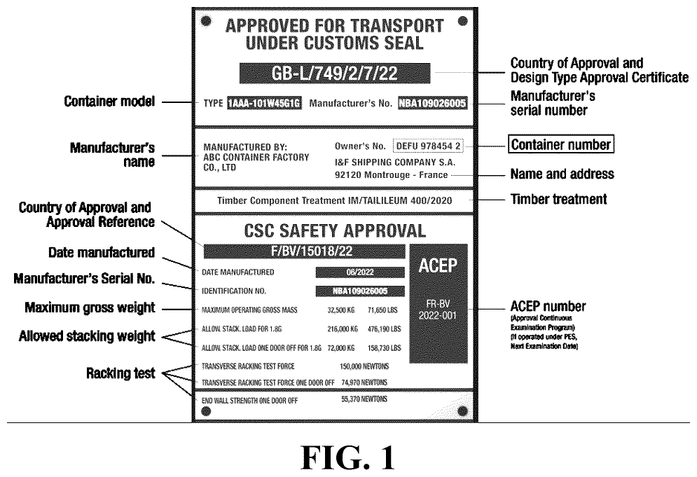

Referring to FIG. 1, an example of a typical CSC plate is shown containing important safety approval information about the shipping container. The International Convention for Safe Containers (CSC) certifies that the container is a safe container because it has been tested according to strict procedures and meets specific requirements. The International Convention for Safe Containers requires that any container used for international transport must be fitted with a valid safety approval plate (CSC plate). The CSC plate is fastened to every shipping container at the time of manufacture and is typically riveted to the outside of the left door of the container. All of the information on the CSC plate can also be incorporated within the QR code. The QR code may not replace the CSC plate, but can still contain all of the safety approval information presented on the CSC plate, as well as other data that may change from time to time, such as the particular contents of the container, which obviously is temporary information that will change with each separate transport of the container from an initial shipping point to a final destination.

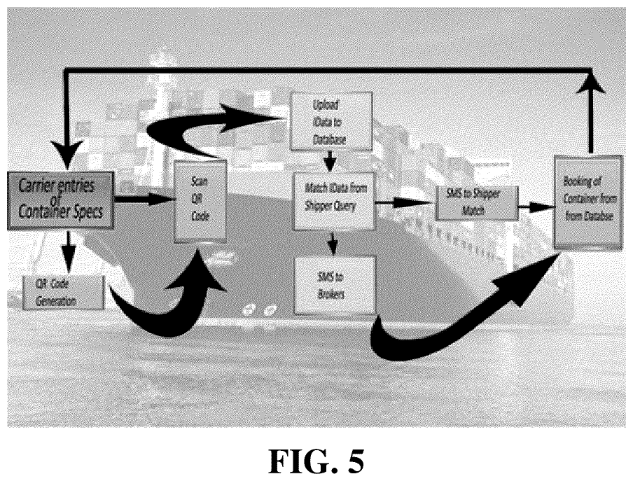

FIG. 5 shows the general sequence of operation of the container tracking system and method of the present invention. Initially, a carrier enters the specifications of a particular shipping container in the system, using a computer and specific computer program, and the container specifications are then incorporated into a generated QR code. The QR code is then printed on a label or other flat substrate which is then affixed to the particular shipping container. Thereafter, the QR code can be scanned using an ordinary smartphone/cellphone to obtain the container specifications. The QR code contains the URLs of the container location management websites. When the QR code is scanned, the smartphone/cellphone automatically connects to the URL(s) and the container specifications are then uploaded to the container tracking and location database(s). The scanned data is then matched to the query of a shipper to identify the particular container. An SMS message is then sent to brokers and/or to the shipper indicating a match. The location of the shipping container is identified, as well as the status of the container, such as whether it is full or empty. Booking for use of the shipping container can then be performed through the database of the system of the present invention.

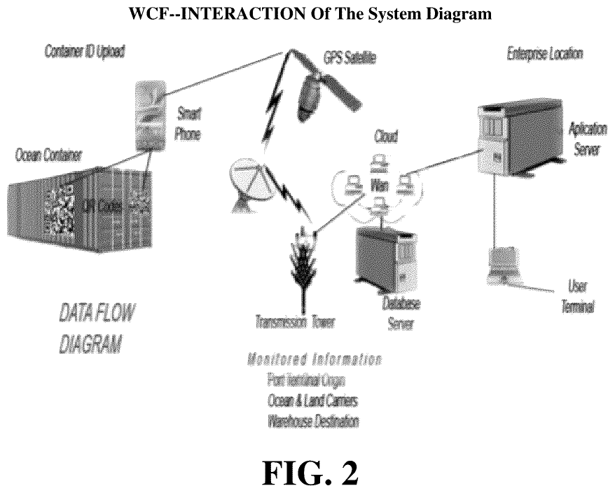

Referring to FIG. 2, the flow of scanned data from the QR code is illustrated. As mentioned above, the QR code affixed to the outside of the shipping container is initially scanned, typically with the use of a standard cell smartphone, which then transmits the scanned data via a GPS satellite to a transmission tower or antenna. From there, the data is directed to a database server. More particularly, the scanned data from the QR code, including all information relevant to the container, is uploaded to a website with software that allows set up of automated emails and in-app notifications. Thereafter, important notifications are sent to shipping companies, container owners and other interested parties. This information includes details about the container type, size, contents, current location and other particulars, along with ETA at destination. This software is Web-based asset tracking software that can be integrated with a number of other business software.

Dynamic QR codes applied to each shipping container contain URLs to entire container location management websites. Scanning the dynamic QR code on a shipping container will automatically open up a website or even a specific page within the site in the cloud.

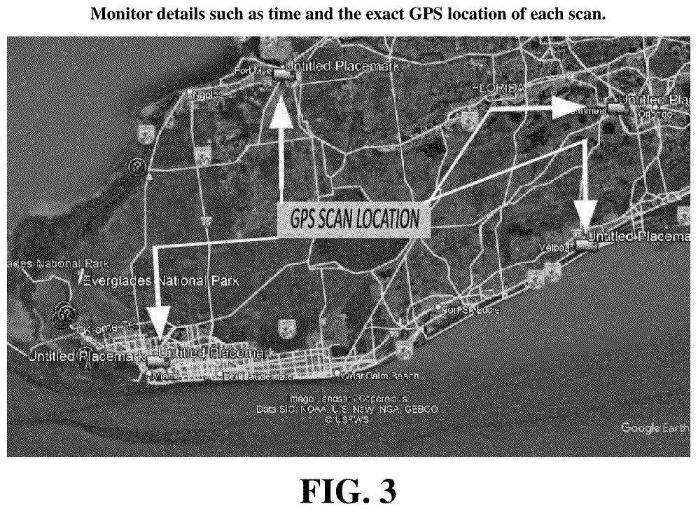

A third-party user can login to the server and enter the container characteristics desired. An automatic match is made with the dynamic inventory of container-type layered over a geographic area based on collected data per shipping cycle. An automated email notification is sent to the inquiring party when a match is made (i.e., the particular shipping container is identified, including all tracking information). Referring to FIG. 3, an example of a GPS map display that is presented on the user's computer terminal (e.g., desktop or laptop computer) is shown. This GPS map display will illustrate the current physical location of all shipping containers that have been identified in the search by the user. This may be a single shipping container, or multiple shipping containers that may be in the same geographic area or anywhere in the world.

Additionally, the system generates automated email notifications to the carriers-owners of a container-match so that a freight rate and a booking can be made for return voyage. The entire process is repeated for the new booked cargo applying and using the same methodology.

Since many modifications, variations and changes in detail can be made to the described embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A method for worldwide tracking of shipping containers comprising the steps of:
obtaining specifications of each of a plurality of shipping containers including information on a CSC plate attached to each of the plurality of containers;
generating a QR code specific to each of the plurality of shipping containers and each generated QR code containing specific identifying information concerning a particular shipping container among the plurality of shipping containers, and the identifying information including the specifications and the information on the CSC plate for the particular container;
placing the QR code on an exterior of the particular shipping container to provide a low profile, easily accessible tracking device that does not require electric power and which is resistant to damage or separation from the shipping container;
scanning the QR code with a GPS-enabled portable electronic computer device at a point of shipping origin;
determining the geographic location of the particular shipping container at the time of scanning the QR code using GPS location technology provided via the GPS-enabled portable electronic computer device;
capturing data including the specific identifying information from the scanned QR code and the determined geographic location of the particular shipping container at the time of scanning the QR code;
transmitting the scanned and captured data and geographic location to a computer database server supporting one or more container management websites with asset tracking software installed;
allowing a first user on a first computer server device to access the database server via the one or more container management websites and obtain the identifying information and location tracking information of the plurality of shipping containers including the particular shipping container;
allowing a second user on a second user computer device to access the first user computer server and search for the current geographic location of one or more of the plurality of shipping containers, as well as the identifying information of each of the one or more plurality of shipping containers; and
performing a search in the database server until a match is made for the one or more shipping containers and sending an automated email notification to at least the second user when the particular shipping container is identified, including the current geographical location of the shipping container.

2. The method as recited in claim 1 further comprising the steps of:
scanning the QR code on the particular shipping container at any point in time during transit of the particular shipping container to a final destination;
determining the current geographical location of the particular shipping container at the time of scanning the QR code using GPS location technology provided via the GPS-enabled portable electronic device; and
transmitting the current geographical location of the particular shipping container to the computer database server.

3. The method as recited in claim 2 further comprising the step of:
sending an automated email notification to at least one user with the current geographical location of the particular shipping container at a most recent time of scanning the QR code.

4. The method as recited in claim 1 further comprising the step of:
presenting a GPS map display on a monitor connected to at least the first computer server device or the second user computer device, and the GPS map display showing the current location of at least one of the plurality of shipping containers.

5. The method as recited in claim 1 wherein the QR code is a dynamic QR code.

6. The method as recited in claim 5 further comprising the step of:
scanning the dynamic QR code with the GPS-enabled portable electronic computer device and obtaining at least one URL from the dynamic QR code to link the GPS-enabled portable electronic computer device to the one or more container management websites.
